(19) United States
(12) Patent Application Publication
(10) Pub. No.: US 2008/0155267 A1
(43) Pub. Date: Jun. 26, 2008

(54) IDENTITY MANAGEMENT SYSTEM WITH AN UNTRUSTED IDENTITY PROVIDER

(76) Inventor: ZEEV LIEBER, NORTH YORK (CA)

Correspondence Address: RIDOUT & MAYBEE;SUITE 2400, ONE QUEEN STREET EAST, TORONTO, ON, M5C3B1, omitted

(21) Appl. No.: 11/867,801

(22) Filed: Oct. 5, 2007

Related U.S. Application Data
(63) Continuation-in-part of application No. 11/615,989, filed on Dec. 24, 2006.

(51) Int. Cl. H04L 9/32

(52) U.S. Cl. 713/183

(57) ABSTRACT

An Identity Management system in which a User may use a single set of credentials to log into multiple Web Service Providers differs from traditional systems in that none of the WSPs have to rely on assertions issued by an Identity Provider. The Identity Provider remains unaware of the User's credentials and the User's personal information. A three-way cryptographic protocol is employed between the User, the Web Service Provider and the Identity Provider that allows re-use of credentials without exposing the Identity Provider to any sensitive information. At the same time, the Identity Provider provides full set of Identity Management services to the User and to the Web Service Provider, without knowing the identities it is dealing with. In addition, the Identity Provider is deprived of an ability to manipulate the identity data in any way, thus ensuring the Web Service Provider is in full control over the relationship with its customer (the User).

### CROSS REFERENCE TO RELATED APPLICATIONS

This patent application is a continuation-in-part of U.S. patent application Ser. No. 11/615,989, entitled “Identity Management System With An Untrusted Identity Provider” and filed on Dec. 24, 2006.

### FIELD OF THE INVENTION

This invention relates to the field of Password Authentication and Identity Management over a computer network.

### BACKGROUND OF THE INVENTION

An Identity Provider (IdP) serves as a single point of storage of a User's personal information and login credentials. Most Identity Management schemes employed as of this writing rely on an “assertion” generated by the IdP, regarding validity of User's credentials. The assertion may be generated using a standard method, such as the known Security Assertion Markup Language (SAML), or any other proprietary mechanism.

A Web Service Provider (WSP), as the term is used herein, is any online service or website that provides services to Users that have an account with it. Exemplary WSPs include an online book store, an auction website or an online banking service website.

In most known Identity Management schemes, the User tries to access a resource on the WSP, and is redirected to the IdP for authentication. After a successful authentication, the IdP generates an assertion, provides the assertion to the User and directs the User back to the WSP. The User is then able to present the assertion to the WSP; the assertion, being digitally signed, can be validated, by the WSP, with a great degree of reliability. Based on receiving and validating the assertion, the WSP accepts the user.

However, nothing prevents a rogue IdP from generating false assertions, thus tricking an WSP into accepting an unauthorized User. Alternatively, the IdP may be acting in good faith, but the security procedures employed by the IdP may be insufficient to provide a degree of confidence required by the WSP.

In addition, in most Identity Management systems employed today, the IdP is fully aware of the personal identity of all its users. Therefore, the IdP may be exposed to sensitive information, such as credit card numbers, and needs to employ security procedures for adequate protection of this data.

Clearly, a system wherein trust is removed from the IdP is required. Such a system can be a candidate for a Global Identity Management system, since no ongoing business relationship, or trust, is required to exist between the WSP and the IdP.

### SUMMARY OF THE INVENTION

The present invention overcomes known IdP trust issues by introducing cryptographic abilities to the User's side. The User will have a Shared Secret established between himself and each of the WSPs that the User has a relationship with. The IdP will only store this Shared Secret in an encrypted form, so that the IdP itself does not have access to the Shared Secret.

In addition, the present invention deprives the IdP of any exposure to User's personal data by encrypting all the data using Profile Encryption Key and/or Field Encryption Keys on the User's side.

This will eliminate the need for either the User or the WSP to trust the Identity Provider.

In accordance with an aspect of the invention, there is provided, at a service provider, a method of logging in a user. The method includes receiving a user-provided plaintext shared secret and a value uniquely identifying the user and the service provider from the user, transmitting the value uniquely identifying the user and the service provider to an identity provider, receiving an encrypted shared secret from the identity provider, decrypting the encrypted shared secret to obtain a identity provider-provided plaintext shared secret, determining an indication of login success based on a correspondence between the identity provider-provided plaintext shared secret and the user-provided plaintext shared secret and transmitting, to the user, the indication of login success. In a further aspect of the invention a computer readable medium is provided for allowing a processor to carry out this method.

In accordance with an aspect of the invention, there is provided a service provider apparatus including a network interface and a processor. The network interface is for receiving a user-provided plaintext shared secret and a value uniquely identifying a user and the service provider from the user, transmitting the value uniquely identifying the user and the service provider to an identity provider and receiving an encrypted shared secret from the identity provider. The processor is adapted to decrypt the encrypted shared secret to obtain a identity provider-provided plaintext shared secret and to determine an indication of login success based on a correspondence between the identity provider-provided plaintext shared secret and the user-provided plaintext shared secret, thereby allowing the network interface to transmit, to the user, the indication of login success.

In accordance with an aspect of the invention, there is provided a method of registering with a service provider. The method includes selecting a secret to share with a service provider, transmitting the secret to the service provider, encrypting the secret to form an encrypted secret and transmitting the encrypted secret to the identity provider.

In accordance with an aspect of the invention, there is provided a method of registering with a service provider. The method includes transmitting a value uniquely identifying a user to an identity provider, transmitting a value uniquely identifying the service provider to the identity provider, receiving, from the identity provider, an encrypted user profile associated with the user, decrypting the encrypted user profile to obtain a plaintext user profile, encrypting the plaintext user profile with a secret to produce a service provider-specific encrypted user profile, where the secret has been previously shared with the service provider and transmitting the service provider-specific encrypted user profile to the identity provider.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Reference will now be made to the drawings, which show by way of example, embodiments of the invention, and in which:

FIG. 1 illustrates a network topology including a user, a service provider and an identity provider;

FIG. 2 illustrates said network topology of FIG. 1 with indications of example communication protocols that may be employed between the user, the service provider and the identity provider;

FIG. 3 illustrates example steps in a method of creating an account for storage at an identity provider according to example embodiments;

FIG. 4 illustrates an example message flow for a Registration Protocol according to example embodiments;

FIG. 5 illustrates example steps taken by the user of FIG. 1 in a method of registering with the service provider of FIG. 1 according to example embodiments;

FIG. 6 illustrates example steps taken by the service provider of FIG. 1 in a method of registering the user of FIG. 1 according to example embodiments;

FIG. 7 illustrates an example message flow for a Login Protocol according to example embodiments;

FIG. 8 illustrates example steps taken by the user of FIG. 1 in a method of logging in to the service provider of FIG. 1 according to example embodiments;

FIG. 9 illustrates example steps taken by the service provider of FIG. 1 in a method of logging in the user of FIG. 1 according to example embodiments;

FIG. 10 illustrates an example message flow for an Update Protocol according to example embodiments;

FIG. 11 illustrates example steps taken by the user of FIG. 1 in a method of updating a profile stored by the identity provider of FIG. 1 according to example embodiments; and

FIG. 12 example steps taken by the service provider of FIG. 1 in a method of updating a profile associated with the user of FIG. 1 and stored by the identity provider of FIG. 1 according to example embodiments.

### DETAILED DESCRIPTION OF THE EMBODIMENTS

As the number of websites requiring authentication grows, users find themselves having to manage more and more sets of different credentials. Many users will use the same username and password across multiple websites. However, this is not always possible, as websites have different, often conflicting, security policies. Also, a username that is available on one website may be taken on another one.

In addition to credentials, many websites collect other personal information, such as email addresses, phone numbers and credit card numbers. It is not uncommon for an advanced internet user to have an account on tens of websites, with personal information given to most of them. As the personal information changes, it is impossible for the user to recall all the websites he needs to update this information with.

An identity Management System aims to solve these problems by introducing an additional authority that will be responsible for authentication and managing of personal data. A website will turn to this authority each time a user needs to login.

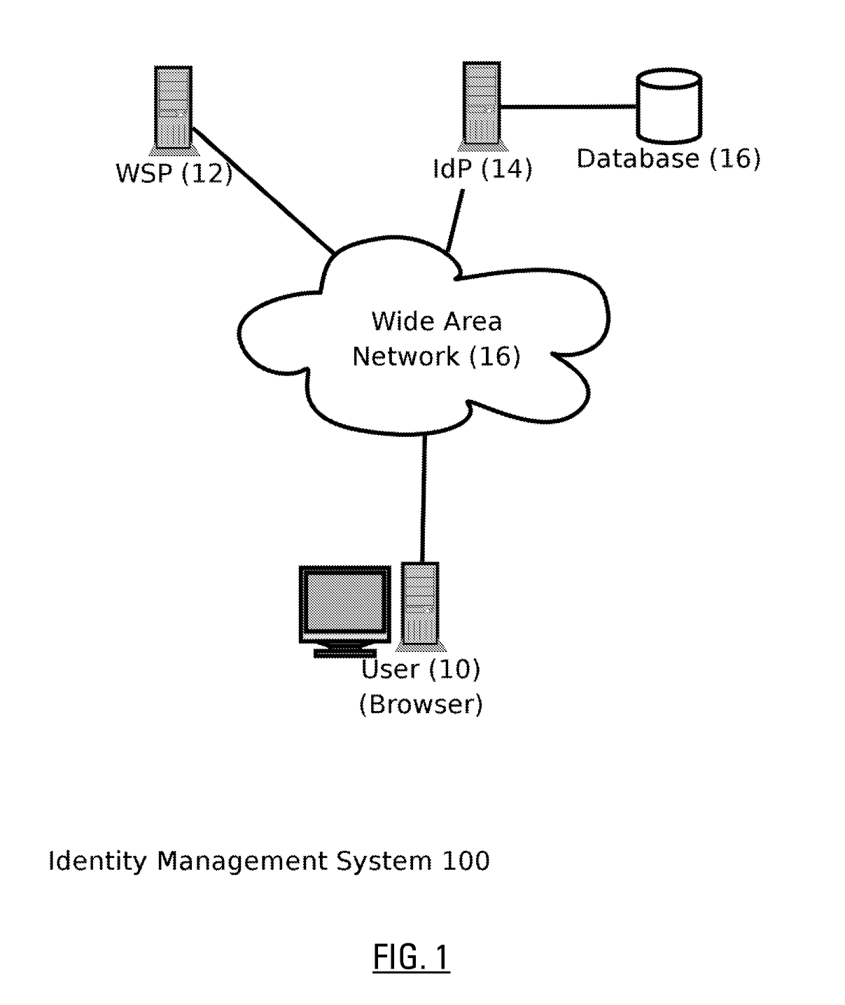

In the description below, an Identity Management System 100 is set in the environment of a public network, such as the Internet. The general view of the system 100 and the actors is shown on FIG. 1. The system 100 consists of three actors, all connected to a wide area data network 16 (e.g., the Internet): a User 10; a WSP 12; and an IdP 14.

The User 10 is any user of the network, human or computer. In the World Wide Web network, this is usually a person using a browser. The User 10 has an Identity which needs to be managed. The Identity of the User 10 consists of a set of credentials and the Personal Data. It is assumed that the User 10 can remember his username and password, but is not able to either remember or store any other cryptographic value. For the following, both the User 10 and the WSP 12 are considered to be apparatus having a network interface (not shown) for transmitting and receiving messages over the wide area data network 16 and a processor (not shown) for processing the messages and generating new messages.

The WSP 12 is any website which requires the User 10 to log in to get access to some personalized services. Examples of such websites are amazon.com and ebay.com.

The IdP 14 is any organization which provides services to the User 10 and the WSP 12. The IdP 14 manages the set of credentials and Personal Data associated with the User 10 and facilitates authentication of the User 10 to the WSP 12.

Any Identity Management system that manages both the user credentials and Personal Data, will implement several basic operations, or protocols. Those operations are Create, Register, Login and Update.

The Create operation helps establish an initial relationship between the User 10 and the IdP 14 by first bringing the User 10 into the system, and then generating initial cryptographic values.

The Register operation establishes a relationship between the User 10 and the WSP 12, as facilitated by the IdP 14.

The Login operation verifies the identity of the User 10 to the WSP 12, or to the IdP 14.

The Update operation informs the WSP 12, and any other WSPs that the User 10 already has a relationship with, of the fact that some of the personal data associated with the User 10 have changed.

Those operations and example flows are presented in more detail below.

The system 100 requires that cryptographic abilities be added to the User's side (i.e., the Browser) of the operations.

In a World Wide Web usage scenario, it may be shown that the cryptographic abilities can be seamlessly added to the User's side using a scripting language, such as the known JavaScript. This way, the proposed Identity Management system 100 of FIG. 1 can be operated using existing Internet infrastructure for the wide area data network 16. A more secure way of implementing the system 100 of FIG. 1 is by putting cryptographic code in a Browser Plug-in, or in Core Browser code. This latter way has the advantage of depriving the IdP 14 of the ability to inject Trojan JavaScript code into User's script.

The User 10 only has one Username and one Password, which are used to access the system 100. Other types of authentication are also suitable for this purpose, as long as they can be used for encryption and decryption.

Since the User 10 may have relationship with numerous WSPs, and each relationship like this will have a separate Shared Secret, the Shared Secret should be encrypted with a Master Key (or Master Secret), which, in turn, can be encrypted with the User's password. This will make password change easier, since only the Master Key will be re-encrypted.

In overview, in order to authenticate to the WSP 12, the User 10 self-identifies to the IdP 14 along with identifying the WSP 12. Responsively, the IdP 14 provides, in an encrypted form, a Shared Secret previously established between the WSP 12 and the User 10. The User 10 then decrypts the Shared Secret and presents the Shared Secret to the WSP 12.

The WSP 12, upon receiving a first Secret from the user, obtains a second secret, which is a copy of the first secret, either from the IdP 14 (using a similar sequence from its side), or from local storage, and compares the first secret to the second secret. If the two secrets are equal, the login is successful. The WSP 12 will then proceed to retrieve the Personal Data associated with the User 10 from the IdP 14.

The Personal Data associated with the User 10 can be encrypted field-by-field, and the keys will be granted by the User 10 to the WSP(s) of the User's choice. This granting of keys will deprive the IdP 14 of the knowledge about its Users and the various WSPs they have relationship with.

Alternatively, the WSP 12 can take charge of the Profile storage altogether; once the Profile is received by the WSP 12, it will be stored locally.

A novel system described herein implements a three-way protocol, which is executed between the User 10, the WSP 12 and the IdP 14. In a case where the Identity Management System 100 is set in the environment of the public Internet, the actors in the system may utilize the following existing Internet communication technologies:
1. The User 10 sends messages to the WSP 12 and to the IdP 14 by means of HTTP or HTTPS requests. The User 10 receives responses back from WSP 12 and IdP 14 by means of HTTP or HTTPS responses.
2. The WSP 12 sends messages to the IdP 14 by means of HTTP or HTTPS requests. The WSP 12 receives responses back from the IdP 14 by means of HTTP or HTTPS responses.

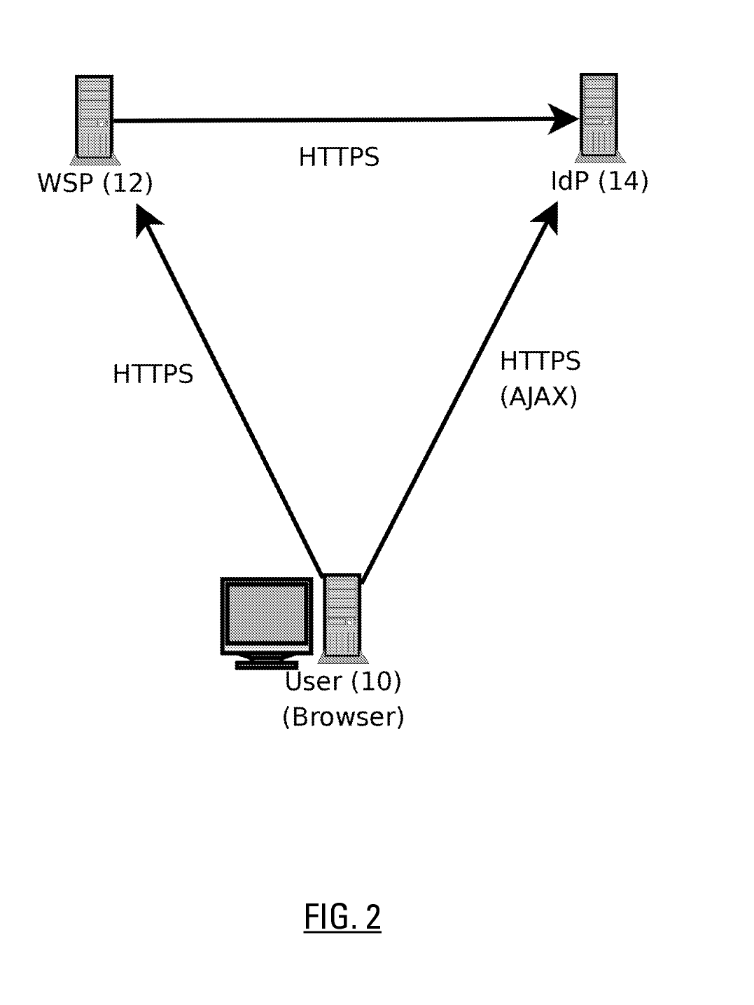

An example of the specific communication technologies employed between each of the communicating parties is shown on FIG. 2.

Several improvements can be made to this basic protocol to deprive the IdP 14 from other, less significant pieces of information, thus weakening the trust bond between the WSP 12 and the IdP 14 even more. Those improvements are:
1. If the WSP 12 stores the Shared Secret on the IdP 14, then the WSP 12 will digitally sign the association of each user and the Shared Secret, so that it cannot be substituted by the IdP 14.
2. The WSP 12 can digitally sign the Personal Data of the User 10, to make sure the data is not changed or substituted.
3. The IdP 14 can digitally sign each association of the User 10 and the Shared Secret of the WSP 12, and the signature will be stored by the WSP 12.
4. If the WSP 12 has signed the personal data of the User 10, then each time the User 10 updates his data, the data is presented to the WSP 12 for re-signing. This data presentation is done by the User 10, and not by the IdP 14. The User is required to first establish a session with the WSP 12 by logging in. This makes sure that it is the real User 10 who is initiating the update, and not the IdP 14.
5. Once an update to the User's Personal Data is made, and the WSP 12 is notified (in case of Signed Personal Data), the WSP 12 can present the data back to the User 10 for approval. This will make sure that the IdP 14 did not manipulate the data during the update process.

Below is an example implementation of the protocol described above. No assumption is made of the technology used on the User's side, which can be JavaScript, Browser Plug-in, Core Browser code or a separate Desktop Application. The section gives the detailed flow of the protocol for the Create operation, the Register operation, the Login operation and the Update operation.

In addition, an option is given to the WSPs to require an Authorization Token A to be provided by the User 10. This is an arbitrary secret value, given by the WSP 12 to the User 10 out-of-band (e.g., received by the User 10 in person in his banking branch) in order to verify the identity of the physical person doing the registration.

For WSPs that maintain their own information about the User 10 (such as handling banking account), a value C can be supplied by the User 10 to indicate his account number. This value is not mandatory if A is present (since it can be retrieved by the WSP 12 using A as a key), but is included for illustration purposes.

In the examples below, a Shared Secret S is generated on the User's side.

In the examples below, the User 10 does not transmit a Username to the IdP 14, nor to the WSP 12 at any time. Instead, a User Handle H is used, which is unique to each server (IdP 14 or WSP 12) that the User 10 is communicating with.

The purpose of using User Handles rather than Username is to restrict the information available to the WSPs and to the IdP 14, achieving greater privacy for the users.

One way to derive a User Handle H is to hash a Username together with some unique identifier which can be reliably linked to the server in question (WSP or IdP). In the World Wide Web environment, the best candidate for such identifier is the server's URL.

Therefore, the User Handle H will be derived in the example below as Hash(Username ∥ URL) where URL is the Uniform Resource Locator (the address) of the website in question (the IdP 14 or the WSP 12). Hash is some secure hash algorithm, like SHA2-256 or better (see Secure Hash Signature Standard (SHS) (Federal Information Processing Standards Publication 180-2), Aug. 1, 2002, available from the National Institute of Standards and Technology (NIST) at csrc.nist.gov/publications/fips/).

It should be noted that only the User 10 has the ability to determine User Handle H, as only the User 10 has access to the Username. The WSP 12 and the IdP 14 will have to rely on values of H transmitted to them by the User 10.

Any time the reference to User Handle H is made, it should be assumed that it is derived as described above.

The Create operation is invoked when a new User 10 wishes to create an account with the IdP 14. The Create operation is only executed between the User 10 and the IdP 14. The Create operation is similar to the Register operation (to be described below), except that, in the Create operation, the IdP 14 takes the role of both a WSP and an IdP.

The goal of the Create operation is to set up initial account information and some cryptographic values, which will allow execution of all other protocols, which are described below.

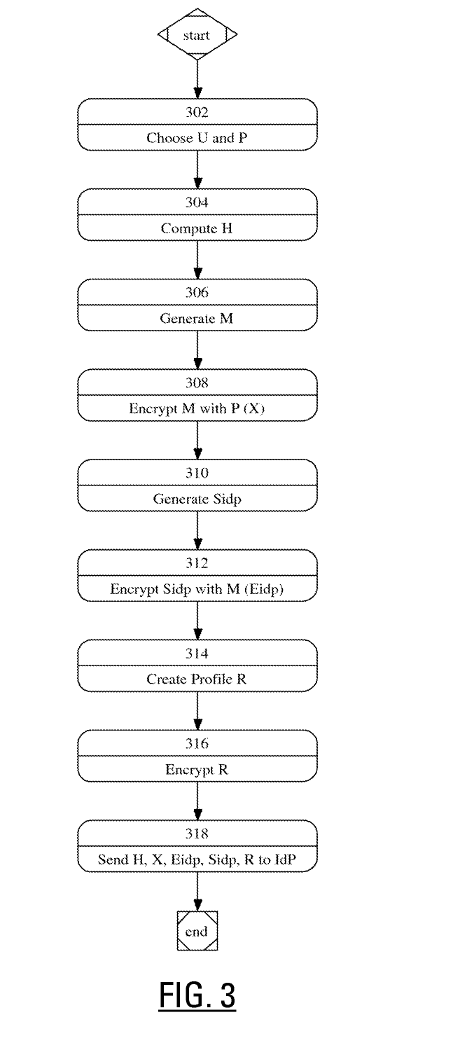

The flow of the Create operation, as carried out by the User 10, is shown in FIG. 3 and proceeds as follows:
1. The User 10 reads an input of a Username U and a Password P (step 302). The choice of U and P may be left to the human user, or may be generated automatically and shown to the human user for future reference.
2. The User 10 determines (step 304) a User Handle H for the IdP, treating the IdP 14 as just another WSP. The User 10 generates a Master Secret M (step 306). A Master Secret is a cryptographically secure random number which is sufficiently long to make its guessing impractical. This secret can be used as a key in subsequent symmetric encryption and decryption operations. In cases where it is unsuitable for direct use as a symmetric key, a Key Derivation Function (KDF), such as one described in RSA Labs PKCS #5 (PKCS #5 v2.0: Password-Based Cryptography Standard RSA Laboratories, 1999, available at www.rsa.com/rsalabs/node.asp?id=2127) may be employed to derive an algorithm-specific symmetric key from the Master Secret.
3. The User 10 encrypts the Master Secret Musing the Password P and, for instance, Password Based Encryption (PBE) (step 308) to obtain an encrypted Master Secret, X: X=PBE_Encrypt(P,M).
4. The User 10 generates a Shared Secret S_{IDP} to be used with the IdP 14 (step 310). The same principles apply to Shared Secret generation and as apply to Master Secret generation.
5. The User 10 encrypts the Shared Secret S_{IDP} using the Master Secret M (step 312) to obtain an encrypted Shared Secret, E_{IDP}: E_{IDP}=Enc(M, S_{IDP}).
6. The User 10 creates a Profile (Personal Data) R (step 314) and encrypts the Profile R with a Profile Encryption Key (step 316): Y=Enc(Profile Encryption Key, R). The Profile Encryption Key may be generated on the spot as a single key or a set of Field Encryption Keys, or the Master Secret M may be used as the Profile Encryption Key.
7. The User 10 transmits the values of H, X, E_{IDP}, S_{IDP} and the encrypted Profile Y to the IdP 14 (step 318). Note that both the encrypted version of the Shared Secret (E_{IDP}) and the plaintext version of the Shared Secret (S_{IDP}) are sent to the IdP 14, due to the IdP 14 acting both as an IdP and as a WSP.

The Register operation is invoked when the User 10 first registers with the WSP 12.

The goal of the Register operation is to establish a relationship between the User 10 and the WSP 12. It is assumed that the User 10 has already established an account with the IdP 14 using the Create operation described above, and now wishes to use that account to log into the WSP 12.

Upon successful completion of the Register operation, the IdP 14, and possibly the WSP 12, will store certain cryptographic values, which cryptographic values will allow subsequent logins of the User 10. In addition, personal information associated with the User 10 will be disclosed to the WSP 12 and will be accessible to the WSP 12 anytime going forward.

For the sake of simplicity, the description below assumes that the User 10 has already decrypted the value M. In case this is not so, the value M can be retrieved and decrypted at any time by performing the steps 802-806 of the Login operation, described later below.

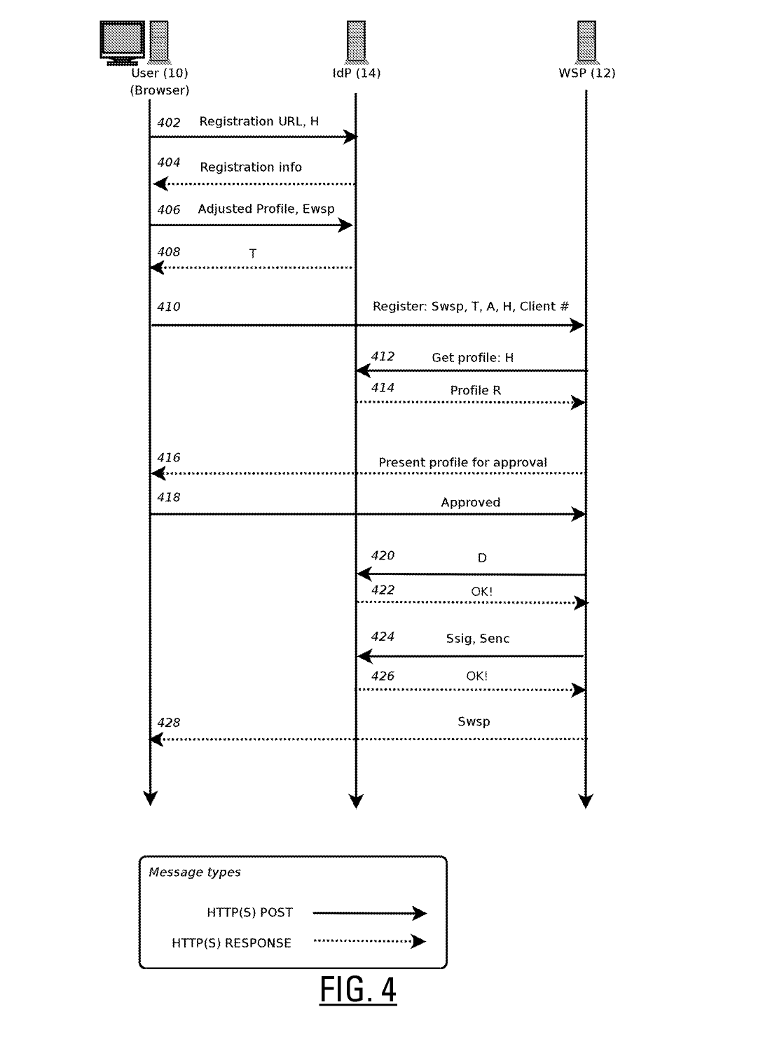

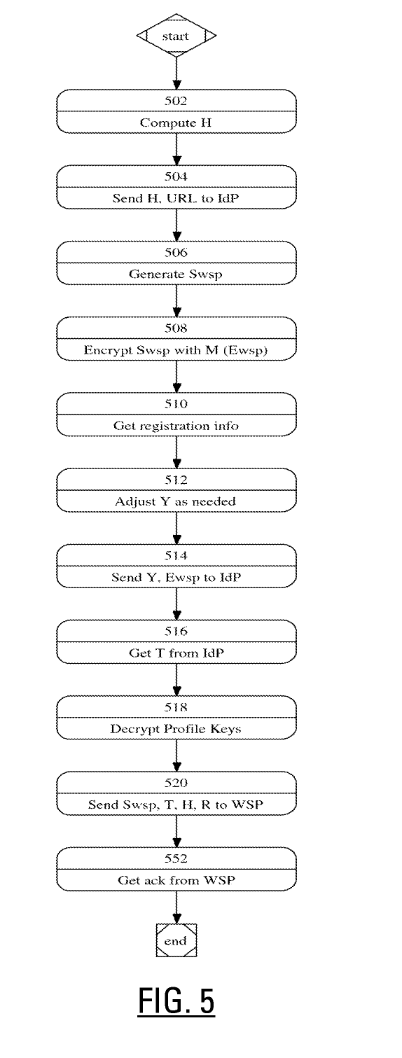

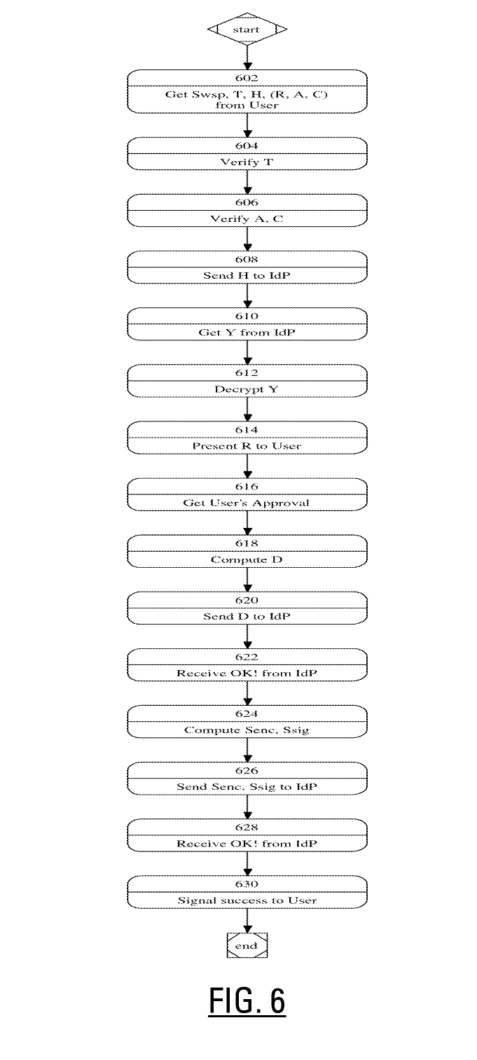

An interaction diagram showing the messages exchanged during the Registration operation is shown on FIG. 4. The flow of the Registration operation from the perspective of the User 10 is shown on FIG. 5. The flow of the Registration operation from the perspective of the WSP 12 is shown on FIG. 6. The Registration operation proceeds as follows:
1. The User 10 browses the website of the WSP 12 and follows a “register” link.
2. The WSP 12 redirects the User 10 to a registration page served by the IdP 14.
3. The User 10 determines a value for User Handle H for this WSP 12 as described above (step 502), where URL is the URL of the WSP 12 the user is registering with, and U is the Username of the User 10. The User 10 sends H and URL to the IdP 14 (step 504) in a registration message 402.
4. The User 10 generates a Shared Secret S_{WSP} to be used with the WSP 12 (step 506).
5. The User 10 determines an Encrypted Shared Secret E_{WSP}: E_{WSP}=Enc(M, S_{WSP}) (step 508).
6. The User 10 receives (step 510) all relevant information (including Encrypted Profile Y) for the registration process, from the IdP 14 in a registration info message 404 that is responsive to the registration message 402. The User 10 decrypts, adjusts and re-encrypts the Encrypted Profile Y (step 512), if necessary, and sends adjusted and re-encrypted Encrypted Profile Y and Encrypted Shared Secret E_{WSP} to the IdP 14 (step 514) in an adjusted profile message 406.
7. The IdP 14 creates a Registration Ticket T:T=Sign(“Register”∥H∥URL)
8. The User 10 receives (step 516), from the IdP 14, the value of T in a Registration Ticket message 408. If separate Profile Encryption Keys are used, the User 10 also receives, in the Registration Ticket message 408 from the IdP 14, the value of Profile Encryption Keys.
9. The User 10 decrypts the Profile Encryption Keys using the Master Secret M (step 518). If Master Secret is used to encrypt the Profile directly, this step is not necessary.
10. The User 10 transmits the values of S_{WSP}, T and H directly to the WSP 12 (step 520) in a WSP registration message 410 that may indicate a presence of the adjusted and re-encrypted Encrypted Profile Y at the IdP 14. The WSP registration message 410 may also include Profile Encryption Keys, or, if Master Secret M is used to encrypt the profile directly, a plaintext version of the Profile R. Optionally, the User 10 also transmits the values of the Authorization Token A and the client number C. Notably, the IdP 14 never sees the value of S_{WSP}.
11. The WSP 12 receives (step 602) the WSP registration message 410 and extracts S_{WSP}, T and H and Profile Keys or Profile R. The WSP 12 verifies registration ticket T using the trusted public key of the IdP 14 (step 604). This way the WSP 12 may be confident that the subscription request is coming from the IdP 14 and not from somebody else.
12. Optionally, the WSP 12 verifies A and C against the database, and builds an association between H and C (step 606). As a result of the building of the association, the handle H of the User 10 is linked to the account number C of the User 10.
13. If the plaintext Profile R was not provided by the User 10, the WSP 12 invokes Get_Profile service of the IdP 14 (step 608). The WSP 12 submits the value of H in a get profile message 412 and receives an unsigned and encrypted profile Y (step 610) from the IdP 14 in a profile message 414. The WSP 12 decrypts the Encrypted Profile Y using the Profile Encryption Keys received from the User 10 in step 602 (step 612). R=Dec(Profile Encryption Keys, Y).
14. Optionally, the WSP 12 transmits R to User 10 (step 614) in a profile-to-user message 416 and, in response, receives (step 616) an approval message 418. Conveniently, by obtaining user's approval, the WSP prevents profile alteration by the IdP.
15. Optionally, the WSP 12 signs the Encrypted Profile Y and generates a Profile Signature D (step 618). The WSP 12 then transmits the Profile Signature D to the IdP 14 (step 620) in a profile signature message 420, thereby invoking a Store_Data_Signature service of the IdP 14. The IdP 14 stores the value of D in the Database 16. Subsequent to the transmission of the Profile Signature, the WSP 12 receives (step 622) an OK! message from the IdP 14.
16. If the WSP 12 wishes to store cryptographic values on the IdP side, the WSP 12 encrypts the value of S_{WSP} with the symmetric key K (step 624): Senc=Enc(K, S_{WSP}); The WSP 12 also signs the encrypted value: Ssig=Sig(“EncryptedSecret”∥ Senc).
17. The WSP 12 transmits H, Ssig, and Senc to the IdP (step 626) in a shared secret storage message 424, thereby invoking the Store_Shared_Secret service of the IdP 14.
18. The IdP 14 stores the H, Ssig, and Senc values in the Database 16 for later use during the Login protocol, and signals success to the WSP 12 in an OK! message 426. The WSP 12 then receives (step 628) the OK! message 426.
19. The WSP 12 then transmits (step 630) an OK! message 428 to the User 10, thereby informing the User 10 that the Registration has been successful.

The goal of this protocol is to authenticate the User 10 to the WSP 12.

Upon a successful completion of this protocol, the WSP 12 will have a cryptographic proof that the User 10 trying to log in knows the same password as the User that performed the Registration protocol (above).

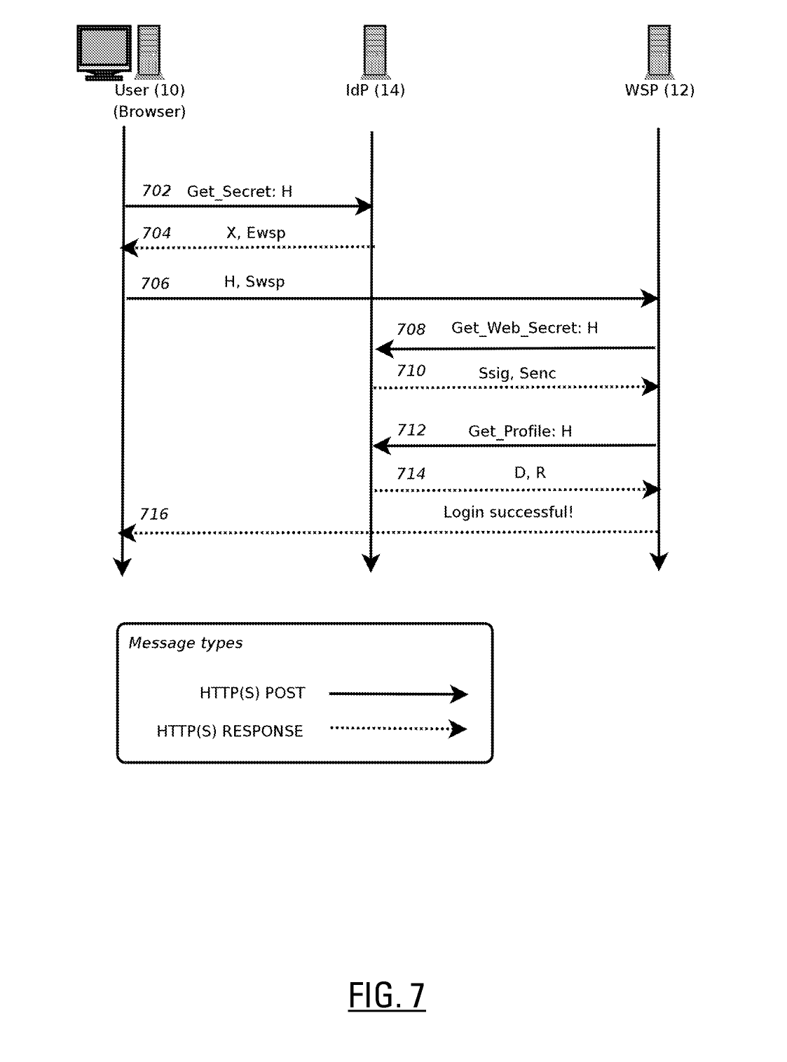

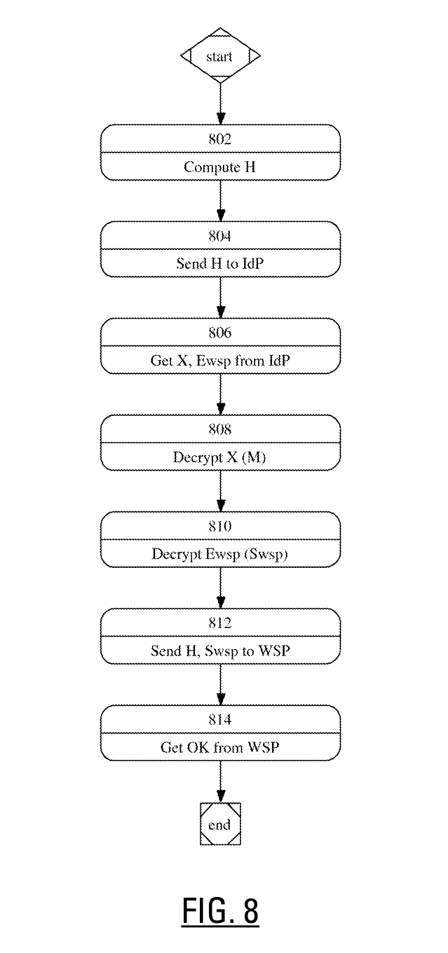

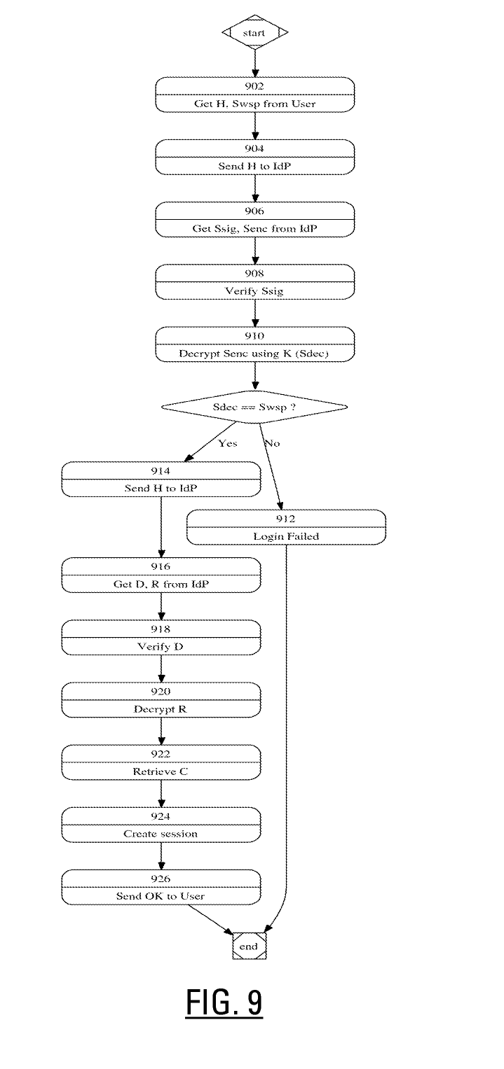

An interaction diagram showing all the messages exchanged during the Login operation is shown on FIG. 7. The flow of the Login operation from the perspective of the User 10 is shown on FIG. 8. The flow of the Login operation from the perspective of the WSP 12 is shown on FIG. 9. The Login operation is comprised of the following steps:
1. The User 10 derives the User Handle H for this WSP, as described above (step 802).
2. The User 10 transmits the value of H to the IdP 14 (step 804) in a Login message 702. While, by sending the H to the IdP 14, the User 10 identifies both the User 10 and the WSP 12, in a less secure embodiment, values identifying the User 10 and the WSP 12 could be sent to the IdP 14 separately.
3. The User 10 receives the values of Encrypted Shared Secret E_{WSP} and Encrypted Master Key X from the IdP 14 (step 806) in a Master Key message 704. In case the user is not registered with the WSP, a dummy value is generated and transmitted instead of E_{WSP} in order not to expose subscription information. The generation of the dummy value should be done in such way that the same value will be returned every time for identical values of H, while at the same time it will be impossible for a third party to distinguish between real values of E_{WSP} and dummy ones.
4. The User 10 decrypts the Master Key M: M=PBE_dec(P, X) (step 808).
5. The User 10 decrypts the Encrypted Shared Secret E_{WSP} to obtain a plaintext shared secret S_{WSP}: S_{WSP}=Dec(M, E_{WSP}) (step 810)
6. The User 10 transmits the values of H and S_{WSP} directly to the WSP 12 (step 812) in a Shared Secret message 706. Notably, the IdP 14 remains unaware of the value of S_{WSP}. Furthermore, the User 10 could opt to only send a value uniquely identifying the User 10 to the WSP 12. While the value uniquely identifying the User 10 sent to the WSP 12 need not be identical to the value uniquely identifying the User 10 sent to the IdP 14, in most practical cases the values will be identical.
7. The WSP 12 receives the value of H from the User 10 (step 902).
8. If the WSP 12 uses the IdP 14 to store cryptographic values, steps 904-910 are performed. Otherwise, S′ is retrieved from elsewhere. The WSP 12 sends the value of H (step 904) to the IdP 14 in a Get Web Secret message 708.
9. The IdP 14 returns the signed and encrypted shared secrets Ssig and Senc (step 906) in Get Web Secret response 710.
10. The WSP 12 verifies the signature Ssig to make sure that correct shared secret was returned (step 908).
11. The WSP 12 decrypts the shared secret using the symmetric key K: S_{DEC}=Dec(K, Senc) (step 910).
12. The WSP 12 verifies that S_{DEC}=S_{WSP}. This means that the User 10 has successfully decrypted the Shared Secret S_{WSP}, meaning that the User 10 possesses the Master Key M, meaning that the User 10 possesses the Password P. If the values are not equal, the WSP 12 sends an indication of an unsuccessful login to the User 10 (step 912) and the method is complete. The unsuccessful login scenario is not shown on FIG. 7.
13. The WSP 12 transmits the value of H to the IdP 14 in a Get Profile message 712 (step 914).
14. The WSP 12 receives the Encrypted Profile Y from the IdP 14 in a Profile Result message 714. Optionally, Data Signature D is also transmitted to the WSP 12 by the IdP 14 (step 916).
15. Optionally, the WSP 12 verifies the signature D (step 918).
16. The WSP 12 decrypts the Encrypted Profile Y (step 920) using its set of Profile Encryption Keys as received from the User 10 during step 520 of the Registration operation. If Master Secret was used to encrypt the Profile R, then the WSP 12 uses its own symmetric key K to decrypt its version of User's Profile.
17. Optionally, the WSP 12 retrieves this user's client number C from its own database, and builds the association between it and the current session (step 922).
18. The WSP 12 creates (step 924) an HTTP session for the User 10.
19. The WSP 12 signals login success (step 926) back to the User 10 in a Login Successful message 716.
20. The User 10 receives (step 814) the Login Successful message 716.

This protocol is invoked each time the User 10 makes changes to the personal data, like modifying address or credit card number.

Upon successful completion of the protocol, personal data of the User 10 stored by the IdP 14 will be updated, and the new value will be stored in an encrypted form. In addition, any WSP 12 that needs to be aware of the change will be notified.

This protocol is performed when the User 10 is logged in with the IdP 14, and therefore the Master Secret M is already decrypted and stored is JavaScript variable or other temporary storage.

All WSPs that will get notified as a result of this protocol, will have a cryptographic proof that the update is done by a legitimate user.

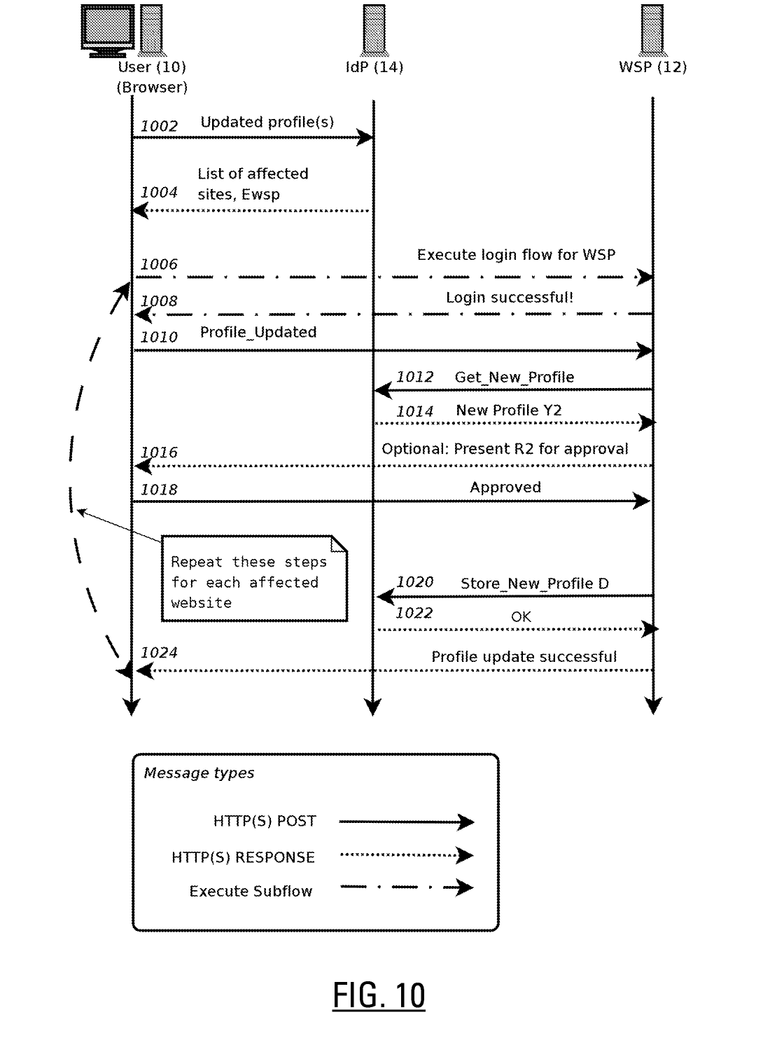

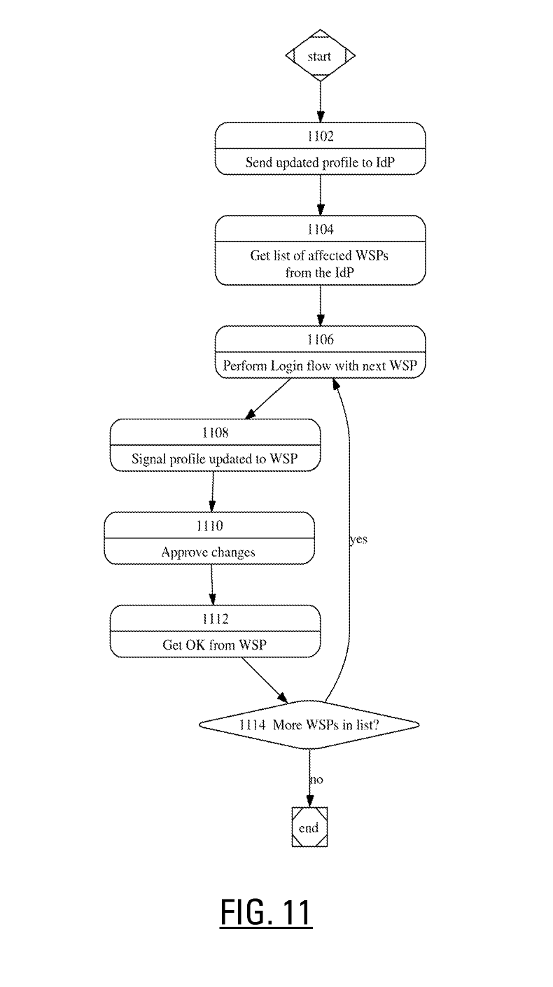

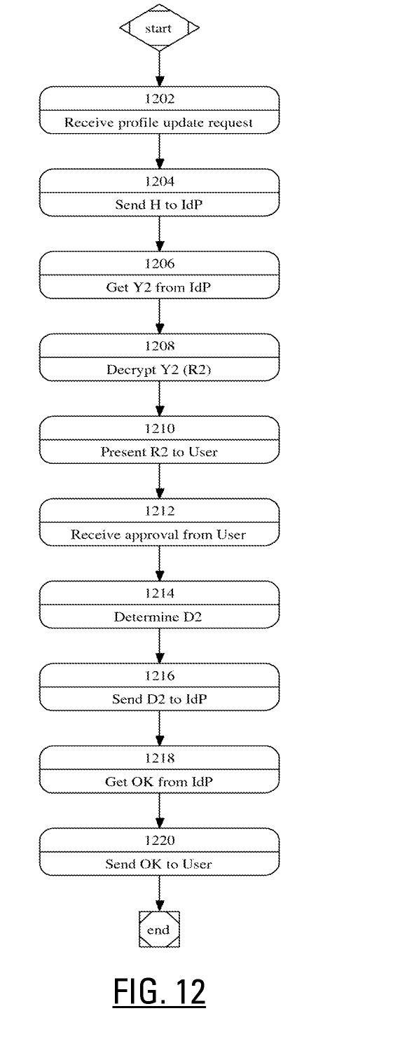

An interaction diagram showing all the messages exchanged during the Profile Update operation is shown on FIG. 10. The flow of the protocol from the perspective of the User 10 is shown on FIG. 11. The flow of the protocol from the perspective of the WSP 12 is shown on FIG. 12. The Profile Update operation is comprised of the following steps:
1. The User 10 logs into the IdP 14 and makes changes to the profiles. As a result of the changes, the User 10 creates a new plaintext version of his profile—R₂ and encrypted version of the same profile Y₂. The User 10 sends the updated and encrypted profile Y₂ to the IdP 14 in an Updated Profile message 1002 (step 1102).
2. The IdP 14 determines the list of websites that need to be notified of the updated profile, and the particular changes that will be visible to each of them by comparing the list of changed fields with the list of fields visible to each of the WSPs. From that list, the IdP 14 selects WSPs registered for Profile Verification. If that list is empty, the protocol is over. If the list is not empty, the User 10 receives from the IdP 14 the list of affected sites, and values of E_{WSP} for each of them (step 1104) in an Update Info message 1004.
3. The User 10 iterates through the list of the affected websites, and for each of these sites the following steps are performed
   (a) The User 10 performs a complete login flow (step 1106) in series of Login messages 1006. At the end of the login flow, the WSP 12 signals the success in a Login Successful message 1008.
   (b) The User 10 notifies the WSP 12 of the profile change (step 1108) using a Profile Updated message 1010. If Profile Encryption Keys are not in use (the Profile R is encrypted using Master Secret or a key derived from it), the User may include the new plaintext profile R₂ in the Profile Updated message 1010, in which case steps 1204-1210 will not be needed.
   (c) The WSP 12 receives profile update notification from the User 10 in the Profile Updated message 1010 (step 1202).
   (d) The WSP 12 transmits the value of H to the IdP 14 (step 1204) in a Get New Profile message 1012. The value of H that the WSP uses is the value derived during the Login protocol in step 1106.
   (e) The WSP 12 receives from the IdP 14 the new encrypted profile Y₂ in a New Profile message 1014 (step 1206).
   (f) The WSP 12 decrypts the new profile Y₂ using Profile Encryption Keys to receive the new plaintext profile R₂ (step 1208).
   (g) Optionally, the WSP 12 can present the profile R₂ (after decryption) back to the User 10 and ask for user's approval of the changes (step 1210).
   (h) The User 10 approves the changes, if asked (step 1110), and sends the approval in a Profile Approval message 1018.
   (i) The WSP 12 receives the approval from the User 10 in the Profile Approval message 1018 (step 1212).
   (j) The WSP 12 determines the new Data Signature D₂: D₂=Sig(“ProfileApproval”∥ H∥ R) (step 1214).
   (k) The WSP 12 transmits the value of D₂ to the IdP 14 in a Store New Profile Signature message 1020 (step 1216).
   (l) The IdP 14 updates the Database 16, and D₂ becomes D. The WSP 12 receives success indication from IdP 14 (step 1218) in an Update Successful message 1022.
   (m) The WSP 12 notifies the User 10 that the update is successful (step 1220) in a User Update Successful message 1024.
   (n) The User 10 receives the success notification from the WSP 12, and moves to the next WSP (step 1112).
   (o) The User 10 determines (step 1114) whether each website on the list of the affected websites has been updated. If there are websites remaining to be updated, the User 10 performs a complete login flow (step 1106) and subsequent steps with the next website on the list. If there are no websites remaining to be updated, the method of FIG. 11 is considered to be complete.

The four operations described above (Create, Register, Login and Update), if implemented correctly, allow the WSP 12 to be sure that even a rogue employee inside the organization of the IdP 14 cannot learn the Shared Secret S_{WSP}, impersonate the User 10, or in any other way to compromise the security of the system.

At the same time, the User 10, by performing its part of the protocol, can be sure that any sensitive information is released only to the parties it is intended for—i.e., the WSP 12.

As will be apparent to a person of ordinary skill in the art of cryptography, “encryption” and “decryption” refer to a set of transformations to the data performed locally. In general, the encryption operation and the decryption operation are representative examples of operations that may be performed by multiple parties in collaboration, by running known protocols between the parties in a manner not described herein.

The above-described embodiments of the present application are intended to be examples only. Alterations, modifications and variations may be effected to the particular embodiments by those skilled in the art without departing from the scope of the application, which is defined by the claims appended hereto.

We claim:

1. At a service provider, a method of logging in a user, said method comprising:
receiving a user-provided plaintext shared secret and a value uniquely identifying said user and said service provider from said user;
transmitting said value uniquely identifying said user and said service provider to an identity provider;
receiving an encrypted shared secret from said identity provider;
decrypting said encrypted shared secret to obtain a identity provider-provided plaintext shared secret;
determining an indication of login success based on a correspondence between said identity provider-provided plaintext shared secret and said user-provided plaintext shared secret; and
transmitting, to said user, said indication of login success.

2. The method of claim 1 wherein said value uniquely identifying said user and said service provider is based, in part, on an identity of said service provider.

3. The method of claim 2 wherein said value uniquely identifying said user and said service provider is based on a username associated with said user.

4. The method of claim 3 wherein said identity of said service provider is a Uniform Resource Locator of said service provider.

5. The method of claim 4 wherein said value uniquely identifying said user and said service provider is determined by hashing said username together with said Uniform Resource Locator of said service provider.

6. A service provider apparatus comprising:
a network interface for:
receiving a user-provided plaintext shared secret and a value uniquely identifying a user and said service provider from said user;
transmitting said value uniquely identifying said user and said service provider to an identity provider; and
receiving an encrypted shared secret from said identity provider;
a processor adapted to:
decrypt said encrypted shared secret to obtain a identity provider-provided plaintext shared secret; and
determine an indication of login success based on a correspondence between said identity provider-provided plaintext shared secret and said user-provided plaintext shared secret;
thereby allowing said network interface to transmit, to said user, said indication of login success.

7. A computer readable medium containing computer-executable instructions that, when performed by a processor, cause said processor to:
receive a user-provided plaintext shared secret and a value uniquely identifying a user and a service provider from said user;
transmit said value uniquely identifying said user and said service provider to an identity provider;
receive an encrypted shared secret from said identity provider;
decrypt said encrypted shared secret to obtain a identity provider-provided plaintext shared secret;
determine an indication of login success based on a correspondence between said identity provider-provided plaintext shared secret and said user-provided plaintext shared secret; and
transmit, to said user, said indication of login success.

8. A method of registering with a service provider, said method comprising:
selecting a secret to share with a service provider;
transmitting said secret to said service provider;
encrypting said secret to form an encrypted secret; and
transmitting said encrypted secret to said identity provider.

9. A method of registering with a service provider, said method comprising:
transmitting a value uniquely identifying a user to an identity provider;
transmitting a value uniquely identifying said service provider to said identity provider;
receiving, from said identity provider, an encrypted user profile associated with said user;
decrypting said encrypted user profile to obtain a plaintext user profile;
encrypting said plaintext user profile with a secret to produce a service provider-specific encrypted user profile, where said secret has been previously shared with said service provider; and
transmitting said service provider-specific encrypted user profile to said identity provider.

10. The method of claim 9 further comprising indicating, to said service provider, a presence of said service provider-specific encrypted user profile at said identity provider.
